(19) United States
(12) Patent Application Publication
(10) Pub. No.: US 2026/0023543 A1
(43) Pub. Date: Jan. 22, 2026

(54) COMPILER SYMBOL TABLE SUPPORT TO AVOID PRIVATE MEMORY SPILLS FOR TEMPORARY ARRAY ACCESSES

(71) Applicant: QUALCOMM Incorporated, San Diego, CA (US)

(72) Inventors: Venkatesh K R, Vijayawada (IN); Suryanarayana Murthy DURBHAKULA, Hyderabad (IN)

(21) Appl. No.: 18/780,358

(22) Filed: Jul. 22, 2024

(51) Int. Cl. G06F 8/41; G06F 9/50

(52) U.S. Cl. CPC G06F 8/441; G06F 8/425; G06F 9/5016

(57) ABSTRACT

This disclosure provides systems, devices, apparatus, and methods, including computer programs encoded on storage media, for processing a representation of source code. A processor may obtain a representation of source code. The processor may determine a first size of a set of temporary arrays of the representation. The processor may determine whether the first size of the set of temporary arrays is less than or equal to a second size of a set of available registers in a compiler symbol table. The processor may allocate the set of temporary arrays to the set of available registers in the compiler symbol table in response to the first size being less than or equal to the second size. The processor may compile the representation of source code to store the set of temporary arrays to the allocated set of available registers. The processor may output an indication of the compiled representation.

### TECHNICAL FIELD

The present disclosure relates generally to processing systems, and more particularly, to one or more techniques for processing a representation of source code.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address the wasted resources used by storing and loading temporary array values in private memory. There is a need for improved memory allocation techniques for temporary arrays.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory and, based at least in part on information stored in the memory, the at least one processor may be configured to obtain a representation of source code. The representation of source code may use a set of temporary arrays. The at least one processor may be configured to determine a first size of the set of temporary arrays based on the obtained representation of source code. The at least one processor may be configured to determine whether the first size of the set of temporary arrays is less than or equal to a second size of a set of available registers in a compiler symbol table. The at least one processor may be configured to allocate the set of temporary arrays to the set of available registers in the compiler symbol table in response to the first size being less than or equal to the second size. The at least one processor may be configured to compile the representation of source code to store the set of temporary arrays to the allocated set of available registers. The at least one processor may be configured to output an indication of the compiled representation of source code.

In some aspects, the techniques described herein relate to a method of processing a representation of source code, including: obtaining a representation of source code including a set of temporary arrays; determining a first size of the set of temporary arrays based on the obtained representation of source code; determining whether the first size of the set of temporary arrays is less than or equal to a second size of a set of available registers in a compiler symbol table; allocating the set of temporary arrays to the set of available registers in the compiler symbol table in response to the first size being less than or equal to the second size; compiling the representation of source code to store the set of temporary arrays to the allocated set of available registers; and outputting an indication of the compiled representation of source code.

In some aspects, the techniques described herein relate to a method, further including: executing the compiled representation of source code based on the output indication.

In some aspects, the techniques described herein relate to a method, where executing the compiled representation of source code includes: storing the set of temporary arrays to the allocated set of available registers in the compiler symbol table.

In some aspects, the techniques described herein relate to a method, where executing the compiled representation of source code includes: loading a value from the set of temporary arrays to the allocated set of available registers in the compiler symbol table.

In some aspects, the techniques described herein relate to a method, where executing the compiled representation of source code includes: selecting an available register from the allocated set of available registers based a variable calculated during an execution of the compiled representation of source code; and storing a first value to the selected available register or loading a second value from the selected available register.

In some aspects, the techniques described herein relate to a method, where the representation of source code includes at least one of: the source code; or an intermediate representation (IR) of the source code.

In some aspects, the techniques described herein relate to a method, further including: identifying the set of temporary arrays as arrays of the representation of source code having an index whose value is unknown during a compile time of the representation of source code.

In some aspects, the techniques described herein relate to a method, further including: allocating the set of temporary arrays to a set of memory locations in a private memory in response to the first size being greater than or equal to the second size; and compiling the representation of source code to store the set of temporary arrays to the allocated set of memory locations in the private memory.

In some aspects, the techniques described herein relate to a method, further including: allocating an index to the set of temporary arrays to the set of available registers in the compiler symbol table in response to the first size being less than or equal to the second size; and storing the index to the allocated set of available registers.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3A illustrates an example of a compiler symbol table that is not used to store an index to a set of temporary arrays of a representation of source code, in accordance with one or more techniques of this disclosure.

FIG. 3B illustrates an example of a compiler symbol table that is used to store an index to a set of temporary arrays of a representation of source code, in accordance with one or more techniques of this disclosure.

FIG. 4A illustrates an example of a set of registers that are not used to store a set of temporary arrays of a representation of source code, in accordance with one or more techniques of this disclosure.

FIG. 4B illustrates an example of a set of registers that are used to store a set of temporary arrays of a representation of source code, in accordance with one or more techniques of this disclosure.

FIG. 5 is a call flow diagram illustrating example communications between a CPU and a GPU in accordance with one or more techniques of this disclosure.

FIG. 6 is a flowchart of an example method of processing a representation of source code in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a processor (e.g., computer processor, graphics processor, graphics processor system) may obtain a representation of source code. The representation of source code may be, for example, the source code itself (e.g., raw source code), or an intermediate representation (IR) of the source code. The source code may include a set of temporary arrays. Temporary arrays may be arrays used by a representation of source code that are used to store and load values, but are not written to a private memory for use outside of the compiled program. For example, shader programs may use temporary arrays that are less than 32 floats large. A temporary array may have index values that are not known to the compiler during compile time, and may be used to access a variable of an array during run time of the compiled program. The processor may determine a first size of the set of temporary arrays based on the obtained representation of source code. For example, if an array has four float variables (e.g., “float temp_array[4]”), the size of the array may be 16 bytes (32 bits or 4 bytes multiplied by 4). In other words, the processor may determine that an array with four float variables will use 16 bytes of registers to store values in a set of registers. The processor may determine whether the first size of the set of temporary arrays is less than or equal to a second size of a set of available registers. The second size of the set of available registers may be a threshold number of registers T that the processor will allocate at a maximum to store such temporary accesses. The threshold number of registers T may be based on the number of general purpose registers (GPRs) accessible by a processor (e.g., on a GPU), for example T may equal the number of GPRs or may be 80%, or 40% of the number of GPRs accessible by a processor. In some aspects, a processor may define T to vary from workload to workload. In some aspects, a user may set T using a compiler command line parameter. The processor may store an index to the array, for example a set of index numbers and a set of corresponding addresses to registers, in a compiler symbol table. The processor may calculate the second size of the set of available registers based on a compilation of a threshold number of representative programs (e.g., a set of 1000 graphics shaders) to accumulate a representative distribution of unused registers for the representative programs. The representative distribution may be used to calculate the threshold number of registers T (e.g., the average of the representative distribution, the median of the representative distribution, the bottom 20% of the representative distribution, the minimum number of the representative distribution). The processor may allocate the set of temporary arrays to the set of available registers in the compiler symbol table in response to the first size being less than or equal to the second size. In some aspects, the processor may allocate the set of temporary arrays to the set of available registers in the compiler symbol table in response to the first size being less than or equal to a sum of the second size and a size of an index associated with the second size (e.g., (size of temporary arrays)+ (size of index to temporary arrays)). The processor may compile the representation of source code to store the set of temporary arrays to the allocated set of available registers during runtime of the compiled representation of source code. The processor may output an indication of the compiled representation of source code. For example, the processor may output a compiled object for execution by a GPU.

In some aspects, a compiler may use general purpose registers to store data for temporary arrays of a representation of source code. The compiler may store the register references in a compiler symbol table along with the array indexes. In order to load data from an array at a specific index, a compiled program may look up the index in the symbol table and get the register associated with the index value. The number of registers may be based on a temporary array size. For example, if the array size is 4 floats, then a full register, or four 32-bit registers, may be used to store the array. The size of the symbol table may be the size of the array. In order to store a value in a register based on an index value, a processor may compare a specified index value with all array index values. The compiler may use different registers to store the data for each index. The index value and the register associated with the index value may be stored in the symbol table. To load, the processor may compare the specified index value with all index values and get the register for the specific index value from the symbol table.

Particular aspects of the subject matter described in this disclosure can be implemented to realize one or more of the following potential advantages. In some examples, by storing temporary arrays in general purpose registers using a compiler symbol table, the described techniques can be used to optimize storing and loading data for temporary arrays by using faster memory accesses (e.g., accessing general purpose registers and the compiler symbol table) instead of slower memory accesses (e.g., accessing private memory off the processor chip).

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

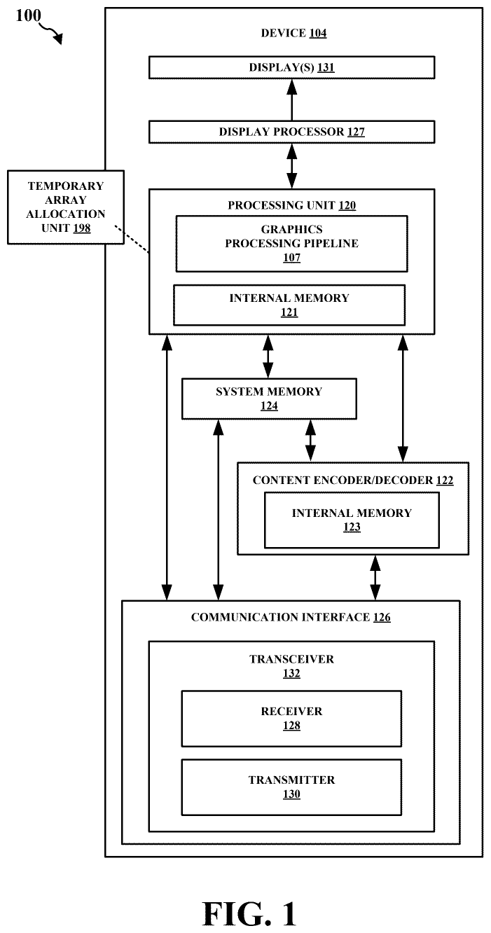

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The internal memory 121 may include a compiler symbol table and general purpose registers. The internal memory 121 may also be referred to as local memory, or on-chip memory. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The system memory 124 may be referred to as private memory. In some aspects, the processing unit 120 may use more resources to access the system memory 124 than the internal memory 121. For example, a store, or a move, instruction of a value into a memory location may take 1 cycle when the memory location is a register of the internal memory 121, but 300 cycles when the memory location is the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a temporary array allocation unit 198 configured to obtain the representation of source code comprising a set of temporary arrays. The temporary array allocation unit 198 may be configured to determine a first size of the set of temporary arrays based on the obtained representation of source code. The temporary array allocation unit 198 may be configured to determine whether the first size of the set of temporary arrays is less than or equal to a second size of a set of available registers in a compiler symbol table. The temporary array allocation unit 198 may be configured to allocate the set of temporary arrays to the set of available registers in the compiler symbol table in response to the first size being less than or equal to the second size. The temporary array allocation unit 198 may be configured to compile the representation of source code to store the set of temporary arrays to the allocated set of available registers. The temporary array allocation unit 198 may be configured to output an indication of the compiled representation of source code. Although the following description may be focused on processing a representation of source code for graphics processing (e.g., graphics shaders), the concepts described herein may be applicable to other similar processing techniques for compiling any programs for execution on a chip having local memory resources, such as general purpose registers and compiler symbol tables.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

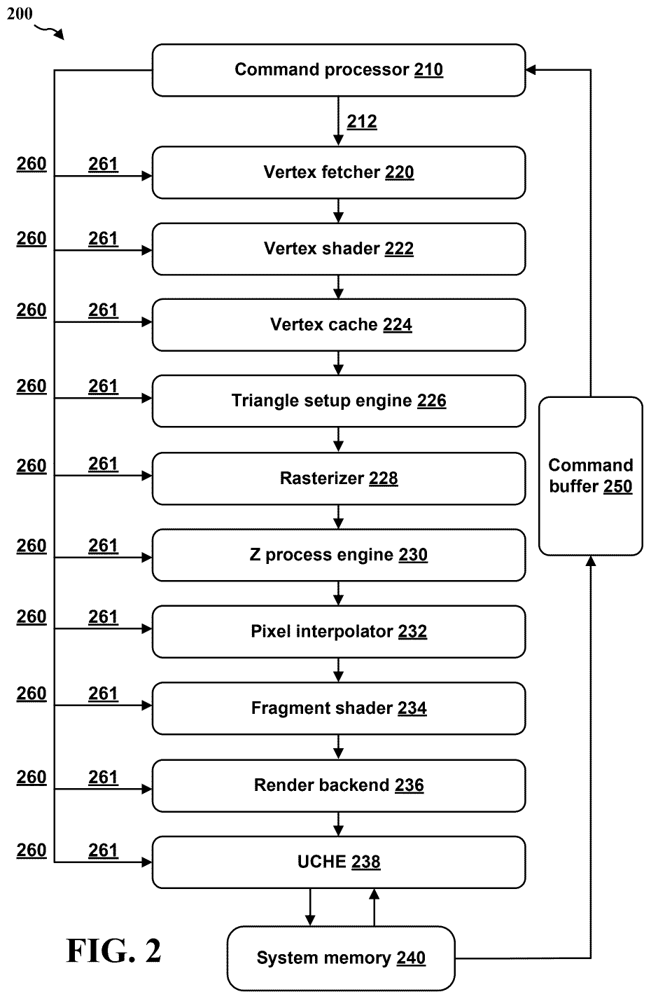

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

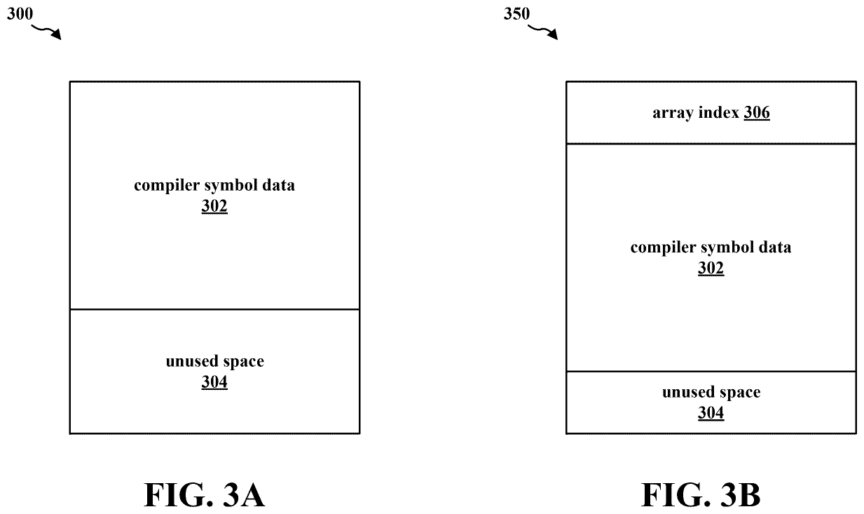

FIG. 3A illustrates a compiler symbol table 300 that may be used to store compiler symbol data 302, for example identifiers of symbols and corresponding locations/addresses of the symbol. The compiler symbol table 300 may have unused space 304 that may be used to store an index to an array. In some aspects, a temporary array allocation unit, such as the temporary array allocation unit 198 in FIG. 1, may be configured to track use of a compiler symbol table to determine a representative distribution of unused space may exist in a compiler symbol table. The temporary array allocation unit may determine a threshold index size I, or a threshold number of registers T, based on the representative distribution of unused space.

FIG. 3B illustrates a compiler symbol table 350 that may be used to store compiler symbol data 302 and an array index 306. The compiler symbol table 350 may also have unused space 304. In some aspects, a compiler may allocate a first portion of the compiler symbol table 350 to store the array index 306, and may use the rest of the available space of the compiler symbol table 350 to store the compiler symbol data 302 for compiling a representation of source code. In some aspects, the compiler may allocate the first portion of the compiler symbol table 350 to store the array index 306 in response to a size of the array index 306 being less than or equal to a threshold index size I, or a corresponding size for a threshold number of registers T.

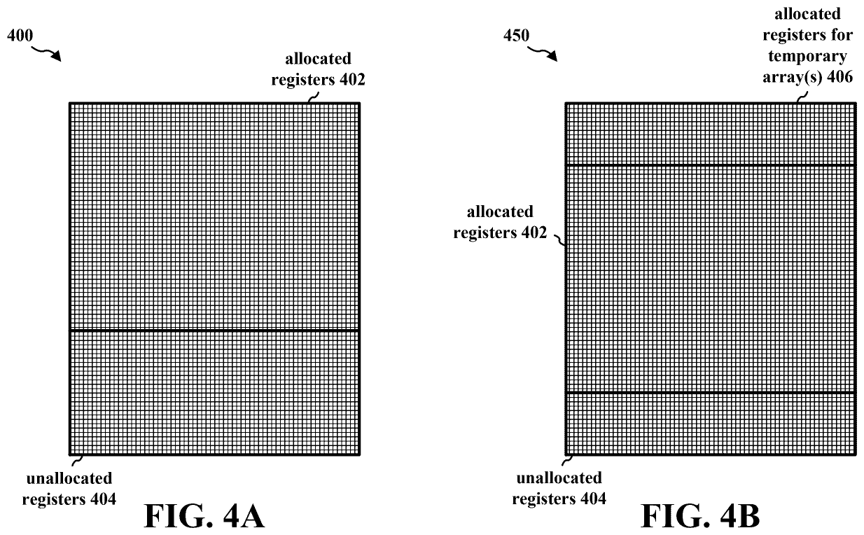

FIG. 4A illustrates a set of registers 400. The set of registers 400 may be general purpose registers that may be used to temporarily store data, for example compiler symbol values. The set of registers 400 may have a set of allocated registers 402 and a set of unallocated registers 404 during the run time of a compiled program. The set of unallocated registers 404 may be may be used to store values of a temporary array. In some aspects, a temporary array allocation unit, such as the temporary array allocation unit 198 in FIG. 1, may be configured to track use of a set of registers, such as the set of registers 400, to determine a representative distribution of unused registers when executing a representative program during run time. The temporary array allocation unit may determine a threshold number of registers T that may be available for use for a set of temporary arrays, based on the representative distribution of unused space.

FIG. 4B illustrates a set of registers 450. The set of registers 400 may be general purpose registers that may be used to temporarily store data, for example compiler symbol values and temporary arrays. The set of registers 450 may also have the set of unallocated registers 404. In some aspects, a compiler may allocate a first portion of the set of registers 450 as the allocated registers 406 for a set of temporary arrays to store temporary array data, and may use the rest of the available registers of the set of registers 450 to store other temporary data, such as compiler symbol values for compiling a representation of source code. In some aspects, the compiler may allocate the allocated registers 406 of the set of registers 450 to store the set of temporary arrays in response to a size of the set of temporary arrays being less than or equal to a threshold of registers T.

A symbol table may be used by a compiler to store information on each identifier in the program source code. Exemplary identifiers may include, for example, a symbol, a constant, a procedure, or a function in a program. The symbol table may be associated with information relating to the identifier's declaration or appearance in the program source code. In other words, an entry of a symbol table may store information related to the entry's corresponding symbol. A symbol table may be embedded in the output generated by the compiler. An exemplary non-optimized symbol table may be represented by Table 1 below:

TABLE 1
Non-Optimized Symbol Table

| Symbol | Information on Symbol |
|---|---|
| Symbol1 | Symbol1 Information |
| Symbol2 | Symbol2 Information |
| Symbol3 | Symbol3 Information |
| Symbol4 | Symbol4 Information |
| Symbol5 | Symbol5 Information |

In some aspects, a symbol table may allocate some of the symbol tables to store information on temporary array data, such as the allocated registers 406 for a set of temporary arrays to store temporary array data in FIG. 4B. An exemplary optimized symbol table may be represented by Table 2 below:

TABLE 2
Optimized Symbol Table

| Symbol | Information on Symbol |
|---|---|
| Symbol1 | Symbol1 Information |
| Temp Var1 | Reg1 |
| Temp Var2 | Reg2 |
| Symbol2 | Symbol2 Information |
| Symbol3 | Symbol3 Information |

The symbols Temp Var1 and Temp Var2 may be indices to the allocated registers 406.

In some aspects, a GPU driver may pass compilation/optimization flags to the GPU compiler to compile shader programs of a program source code (e.g., a game). The GPU compiler may use such flags to compile shader programs, generate assembly instructions, and allocate/assign registers (e.g., via a register allocator) to the shader programs to produce an executable program. The GPU driver may also initialize and configure a GPU to run an executable program on the GPU.

In other aspects, the GPU driver may also include a compilation step for the compiler to use its compiler symbol table during the compilation step-particularly with respect to temporary arrays. In other words, during the compilation, the compiler may also construct the symbol table, use the symbol table to keep track of temporary arrays, and then delete the symbol table after use or after final assembly code generation. The GPU compiler may use compilation/optimization flags received from the GPU driver to compile shader programs of a program source code. The temporary registers may hold temporary array values which may be used to avoid spills. In other words, the compiler symbol table may hold register references of temporary array indexes. The register allocator may allocate registers to temporary array values and the shader programs based on the above allocated registers and optimized compiler symbol table. In other words, the GPU compiler may allocate/assign registers (e.g., via a register allocator) to temporary arrays and shader programs. The GPU compiler may construct the symbol table for the temporary arrays and use the symbol table during the code generation phase. Once the GPU compiler generates the final assembly instructions, the GPU compiler may remove/delete the symbol table and generate an executable program. The executable program may be provided to the GPU driver by the GPU compiler for execution by the GPU.

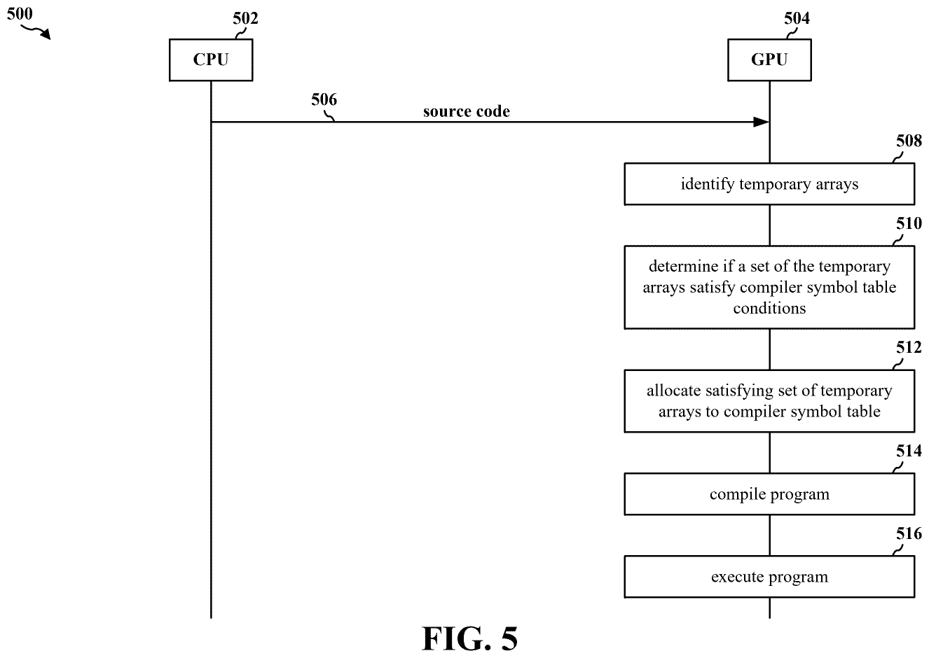

FIG. 5 is a call flow diagram 500 illustrating example communications between a CPU 502 and a GPU 504, in accordance with one or more techniques of this disclosure.

A CPU 502 may transmit an indication of a representation of source code 506 to the GPU 504. The GPU 504 may receive the indication of the representation of source code 506 from the CPU 502. The representation of source code 506 may include the source code itself, or an IR of the source code.

At 508, the GPU 504 may identify temporary arrays in the representation of source code 506. Such temporary arrays may be used to store and load values temporarily. In other words, the values may not be written to a private memory for use outside of the compiled program. The GPU 504 may identify temporary arrays of the representation of source code 506 that may have index values that are not known to the compiler during compile time, and may be used to access a variable of an array during run time of the compiled program. Such dynamic indexes may be used to store data into the temporary array and to load data from the temporary array. The GPU 504 may identify all temporary arrays of the representation of source code 506 having dynamic indexes that are not known during compile time.

At 510, the GPU 504 may determine if at least a subset of the identified set of temporary arrays may satisfy a set of compiler symbol conditions. The GPU 504 may use additional registers for storing temporary array accesses instead of using private memory (e.g., off-chip memory) and may store those register references in a symbol table. As there may be additional pressure on the general purpose registers, the GPU 504 may set a threshold number of registers T that will act as a maximum number of registers to store such temporary accesses. In some aspects, the GPU 504 may determine the number of registers that may be used for the set of temporary arrays identified at 508, and, in response to the number being less than or equal to the threshold T, the GPU 504 may allocate a set of general purpose registers for the set of temporary arrays, or, in response to the number being greater than or equal to the threshold T, the GPU 504 may not allocate a set of general purpose registers for the set of temporary arrays. In other aspects, the GPU 504 may select a subset of the identified set of temporary arrays to use for rapid temporary array access such that the number of allocated general purpose registers for the subset is as close to the threshold T as possible without exceeding the threshold T. In some aspects, the GPU 504 may determine the value of the threshold T after careful experimentation. In some aspects, the GPU 504 may analyze a tradeoff between avoiding accesses to private memory verses creating additional register pressure in the shader program to calculate the value of the threshold T.

At 512, the GPU 504 may allocate registers to the satisfying set of temporary arrays determined at 510. The GPU 504 may remove the registers from the available set of registers for other register allocation (e.g., registers used for symbols of the compiler). For example, if the total number of registers available for a program are 32, and the GPU 504 allocates two registers for the temporary array, then the GPU 504 may reserve those two registers for temporary array access and use the remaining 30 registers for other register allocation. In other words, the GPU 504 may allocate those two registers for the temporary array before register allocation. The GPU 504 may also allocate a portion of the compiler symbol table for an index to the set of temporary arrays.

At 514, the GPU 504 may compile the program based on the representation of source code 506 and the allocated registers and portion of the compiler symbol table for the index to the set of temporary arrays. At 516, the GPU 504 may execute the compiled program.

During run time, the GPU 504 may use the allocated general purpose registers to store data of the set of temporary arrays allocated at 512. The GPU 504 may store the register references in the compiler symbol table along with array indexes. When the GPU 504 loads data from the set of temporary arrays at a specific index, the GPU 504 may look up the index in the compiler symbol table and obtain the register associated with the index value. The number of registers used may be based on the size of the set of temporary arrays. For example, if the array size is 4 floats, then the GPU 504 may use a full register, or four 32-bit registers, to store the values of the array having 4 floats. The size of the symbol table may be the size of the array.

When performing a store, the GPU 504 may manually compare the current index value with all array index values, as the GPU 504 knows that the index of the array will not exceed the array size. The compiler of the GPU 504 may use different registers to store the data for each index. The index value and the register associated with the index value may be stored in the compiler symbol table.

For example, an index symbol table for a temporary array having an array size of 4 may be represented by Table 3 below:

TABLE 3
Initial index symbol table

| index_value | register |
|---|---|
| 0 | r0.x |
| 1 | r0.y |
| 2 | r0.z |
| 3 | r0.w |

The GPU 504 may use an iterated comparison to determine where to store data, for example, using the following pseudocode:
if (r2·x==0) mov r0·x, 42·y
else if (r2·x==1) mov 10·y, r2·y
else if (r2·x==2) mov r0·z, r2·y
else mov r0·w, r2·y

Register r2·x may contain an index value, and register r2·y may hold data to store at the index associated with register r2·x. If the value of r2·x is 1, then the GPU 504 may store the value stored in register r2·y into the register r0·y.

The iterated comparison may be replaced by a single select statement, for example an arithmetic logic unit (ALU) 3 (ALU3) instruction. Such an instruction may take 1 cycle to complete by the GPU 504. Each mov statement may be an ALU 2 (ALU2) instruction. Such an instruction may take 1 cycle to complete by the GPU 504. In other words, for the GPU 504 to store a value into an allocated general purpose register, the GPU 504 may use 2 cycles. Since it may cost the GPU 504 hundreds of cycles to store a value into private memory, use of a general purpose register on the GPU 504 to store values of a temporary array may be more efficient.

When performing a load, the GPU 504 may manually compare the current index value with all array index values, as the GPU 504 knows that the index of the array will not exceed the array size. The compiler of the GPU 504 may use different registers to store the data for each index. The index value and the register associated with the index value may be stored in the compiler symbol table. The GPU 504 may retrieve the register for a specific index value from the compiler symbol table.

For example, the GPU 504 may use an iterated comparison to determine where to load data from, for example, using the following pseudocode:
if (r2·x==0) mov r1·x, r0·x
else if (r2·x==1) mov r1·x, r0·y
else if (r2·x==2) mov r1·x, r0·z
else mov r1·x, r0·w

Referring back to Table 3 above, a register r2·x may contain an index value. The GPU 504 may fetch the register associated with the index value in r2·x from the symbol table and store the value into r1·x. If the value of r2·x is 2, then the GPU 504 may look up the register reference at 2 in the symbol table of Table 3 and store the value saved in r0·w into r1·x

The number of branches in a select statement may and moves for a store or load instruction may be dependent on the size of the array. For each array index, the GPU 504 may use one branch and one move. For example, for an array size of 4, the GPU 504 may use 4 branches and 4 moves. The branches may be in the form of if-else statements so that the compiler of the GPU 504 may easily replace the branches with a select ALU3 instruction. Since the ALU3 select instruction takes one cycle, and the ALU2 mov instruction takes one cycle, the entire overhead for each store or load instruction may be 2 cycles. Since the size of the compiler symbol table may be the size of the array, and since the compiler symbol table may be used during compile time, the overhead for using the compiler symbol table may be negligible. The number of registers used by the GPU 504 may increase as the size of the temporary array increases. For example, for shaders that use small temporary array sizes, the register count may not fluctuate much from one shader to another shader. However, for shaders that use large temporary array sizes, the GPU 504 may use some registers on the GPU 504 to store portions of the large temporary array, and may use private memory off-chip to store the other portions of the large temporary array.

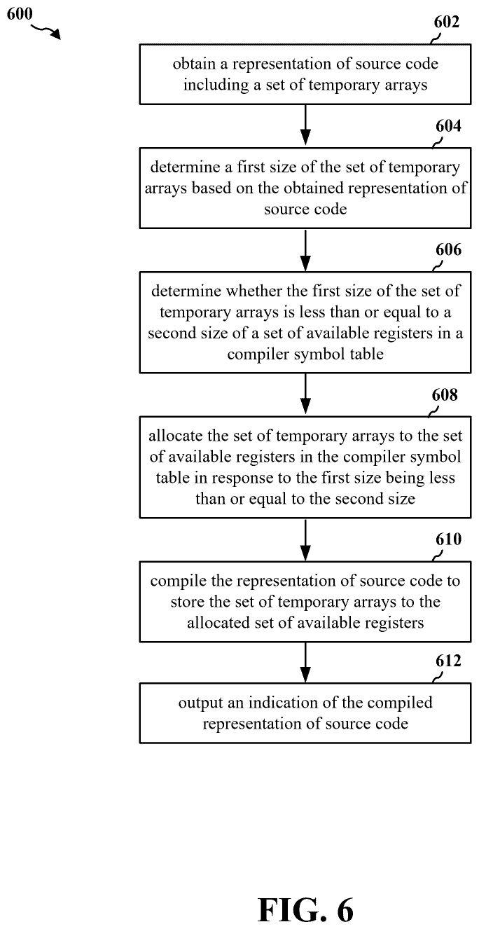

FIG. 6 is a flowchart 600 of an example method of processing a representation of source code in accordance with one or more techniques of this disclosure. The method may be performed by an apparatus, such as an apparatus for graphics processing, a GPU, a CPU, or other display processor, a wireless communication device, and the like, as used in connection with the aspects of FIGS. 1, 2, 3A, 3B, 4A, 4B, and 5.

At 602, the apparatus may obtain a representation of source code including a set of temporary arrays. For example, 602 may be performed by the GPU 504 in FIG. 5, which may obtain a representation of source code including a set of temporary arrays. Moreover, 602 may be performed by the temporary array allocation unit 198 in FIG. 1.

At 604, the apparatus may determine a first size of the set of temporary arrays based on the obtained representation of source code. For example, 604 may be performed by the GPU 504 in FIG. 5, which may determine a first size of the set of temporary arrays based on the obtained representation of source code. Moreover, 604 may be performed by the temporary array allocation unit 198 in FIG. 1.

At 606, the apparatus may determine whether the first size of the set of temporary arrays is less than or equal to a second size of a set of available registers in a compiler symbol table. For example, 606 may be performed by the GPU 504 in FIG. 5, which may determine whether the first size of the set of temporary arrays is less than or equal to a second size of a set of available registers in a compiler symbol table. Moreover, 606 may be performed by the temporary array allocation unit 198 in FIG. 1.

At 608, the apparatus may allocate the set of temporary arrays to the set of available registers in the compiler symbol table in response to the first size being less than or equal to the second size. For example, 608 may be performed by the GPU 504 in FIG. 5, which may allocate the set of temporary arrays to the set of available registers in the compiler symbol table in response to the first size being less than or equal to the second size. Moreover, 608 may be performed by the temporary array allocation unit 198 in FIG. 1.

At 610, the apparatus may compile the representation of source code to store the set of temporary arrays to the allocated set of available registers. For example, 610 may be performed by the GPU 504 in FIG. 5, which may compile the representation of source code to store the set of temporary arrays to the allocated set of available registers. Moreover, 610 may be performed by the temporary array allocation unit 198 in FIG. 1.

At 612, the apparatus may output an indication of the compiled representation of source code. For example, 612 may be performed by the GPU 504 in FIG. 5, which may output an indication of the compiled representation of source code. Moreover, 612 may be performed by the temporary array allocation unit 198 in FIG. 1.

In configurations, a method or an apparatus for processing a representation of source code is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a representation of source code. The source code may include a set of temporary arrays. The apparatus may further include means for determining a first size of the set of temporary arrays based on the obtained representation of source code. The apparatus may further include means for determining whether the first size of the set of temporary arrays is less than or equal to a second size of a set of available registers in a compiler symbol table. The apparatus may further include means for allocating the set of temporary arrays to the set of available registers in the compiler symbol table in response to the first size being less than or equal to the second size. The apparatus may further include means for compiling the representation of source code to store the set of temporary arrays to the allocated set of available registers. The apparatus may further include means for outputting an indication of the compiled representation of source code. The apparatus may further include means for executing the compiled representation of source code based on the output indication. The apparatus may further include means for executing the compiled representation of source code by storing the set of temporary arrays to the allocated set of available registers in the compiler symbol table. The apparatus may further include means for executing the compiled representation of source code by loading a value from the set of temporary arrays to the allocated set of available registers in the compiler symbol table. The apparatus may further include means for executing the compiled representation of source code by (a) selecting an available register from the allocated set of available registers based a variable calculated during an execution of the compiled representation of source code and (b) storing a first value to the selected available register or loading a second value from the selected available register. The representation of source code may include the source code. The representation of source code may include an IR of the source code. The apparatus may further include means for identifying the set of temporary arrays as arrays of the representation of source code having an index whose value is unknown during a compile time of the representation of source code. The apparatus may further include means for allocating the set of temporary arrays to a set of memory locations in a private memory in response to the first size being greater than or equal to the second size. The apparatus may further include means for compiling the representation of source code to store the set of temporary arrays to the allocated set of memory locations in the private memory. The apparatus may further include means for allocating an index to the set of temporary arrays to the set of available registers in the compiler symbol table in response to the first size being less than or equal to the second size; and storing the index to the allocated set of available registers.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of processing a representation of source code, comprising: obtaining a representation of source code comprising a set of temporary arrays; determining a first size of the set of temporary arrays based on the obtained representation of source code; determining whether the first size of the set of temporary arrays is less than or equal to a second size of a set of available registers in a compiler symbol table; allocating the set of temporary arrays to the set of available registers in the compiler symbol table in response to the first size being less than or equal to the second size; compiling the representation of source code to store the set of temporary arrays to the allocated set of available registers; and outputting an indication of the compiled representation of source code.
Aspect 2. The method of aspect 1, further comprising executing the compiled representation of source code based on the output indication.
Aspect 3. The method of aspect 2, wherein executing the compiled representation of source code comprises storing the set of temporary arrays to the allocated set of available registers in the compiler symbol table.
Aspect 4. the method of either of aspects 2 or 3, wherein executing the compiled representation of source code comprises loading a value from the set of temporary arrays to the allocated set of available registers in the compiler symbol table.
Aspect 5. The method of any of aspects 2 to 4, wherein executing the compiled representation of source code comprises: selecting an available register from the allocated set of available registers based a variable calculated during an execution of the compiled representation of source code; and storing a first value to the selected available register or loading a second value from the selected available register.
Aspect 6. The method of any of aspects 1 to 5, wherein the representation of source code comprises at least one of: the source code; or an intermediate representation (IR) of the source code.
Aspect 7. The method of any of aspects 1 to 6, further comprising identifying the set of temporary arrays as arrays of the representation of source code having an index whose value is unknown during a compile time of the representation of source code.
Aspect 8. The method of any of aspects 1 to 7, further comprising: allocating the set of temporary arrays to a set of memory locations in a private memory in response to the first size being greater than or equal to the second size; and compiling the representation of source code to store the set of temporary arrays to the allocated set of memory locations in the private memory.
Aspect 9. The method of any of aspects 1 to 8, further comprising: allocating an index to the set of temporary arrays to the set of available registers in the compiler symbol table in response to the first size being less than or equal to the second size; and storing the index to the allocated set of available registers.
Aspect 10. The method of any of aspects 1 to 9, wherein outputting the indication of the compiled representation of source code comprises: transmitting the indication of the compiled representation of source code; or storing the indication of the compiled representation of source code.
Aspect 11 is an apparatus for processing a representation of source code including at least one processor coupled to a memory and configured to implement a method as in any of aspects 1-10.
Aspect 12 may be combined with aspect 11 and includes that the apparatus is a wireless communication device.
Aspect 13 is an apparatus for processing a representation of source code including means for implementing a method as in any of aspects 1-10.
Aspect 14 is a computer-readable medium storing computer executable code, the code when executed by at least one processor causes the at least one processor to implement a method as in any of aspects 1-10.

Various aspects have been described herein. These and other aspects are within the scope of the following claims.

What is claimed is:

1. An apparatus for processing a representation of source code, comprising:
a memory; and
a processor coupled to the memory and, based at least in part on information stored in the memory, the processor is configured to:
obtain the representation of source code comprising a set of temporary arrays;
determine a first size of the set of temporary arrays based on the obtained representation of source code;
determine whether the first size of the set of temporary arrays is less than or equal to a second size of a set of available registers in a compiler symbol table;
allocate the set of temporary arrays to the set of available registers in the compiler symbol table in response to the first size being less than or equal to the second size;
compile the representation of source code to store the set of temporary arrays to the allocated set of available registers; and
output an indication of the compiled representation of source code.

2. The apparatus of claim 1, wherein the processor is further configured to:
execute the compiled representation of source code based on the output indication.

3. The apparatus of claim 2, wherein, to execute the compiled representation of source code, the processor is configured to:
store the set of temporary arrays to the allocated set of available registers in the compiler symbol table.

4. The apparatus of claim 2, wherein, to execute the compiled representation of source code, the processor is configured to:
load a value from the set of temporary arrays to the allocated set of available registers in the compiler symbol table.

5. The apparatus of claim 2, wherein, to execute the compiled representation of source code, the processor is configured to:
select an available register from the allocated set of available registers based a variable calculated during an execution of the compiled representation of source code; and
store a first value to the selected available register or loading a second value from the selected available register.

6. The apparatus of claim 1, wherein the representation of source code comprises at least one of:
the source code; or
an intermediate representation (IR) of the source code.

7. The apparatus of claim 1, wherein the processor is further configured to:
identify the set of temporary arrays as arrays of the representation of source code having an index whose value is unknown during a compile time of the representation of source code.

8. The apparatus of claim 1, wherein the processor is further configured to:
allocate the set of temporary arrays to a set of memory locations in a private memory in response to the first size being greater than or equal to the second size; and
compile the representation of source code to store the set of temporary arrays to the allocated set of memory locations in the private memory.

9. The apparatus of claim 1, wherein the processor is further configured to:
allocate an index to the set of temporary arrays to the set of available registers in the compiler symbol table in response to the first size being less than or equal to the second size; and
store the index to the allocated set of available registers.

10. The apparatus of claim 1, wherein the apparatus comprises a wireless communication device.

11. The apparatus of claim 1, wherein to output the indication of the compiled representation of source code, the processor is configured to:
transmit the indication of the compiled representation of source code; or
store the indication of the compiled representation of source code.

12. A method of processing a representation of source code, comprising:
obtaining the representation of source code comprising a set of temporary arrays;
determining a first size of the set of temporary arrays based on the obtained representation of source code;
determining whether the first size of the set of temporary arrays is less than or equal to a second size of a set of available registers in a compiler symbol table;
allocating the set of temporary arrays to the set of available registers in the compiler symbol table in response to the first size being less than or equal to the second size;
compiling the representation of source code to store the set of temporary arrays to the allocated set of available registers; and
outputting an indication of the compiled representation of source code.

13. The method of claim 12, further comprising:
executing the compiled representation of source code based on the output indication.

14. The method of claim 13, wherein executing the compiled representation of source code comprises:
storing the set of temporary arrays to the allocated set of available registers in the compiler symbol table.

15. The method of claim 13, wherein executing the compiled representation of source code comprises:
loading a value from the set of temporary arrays to the allocated set of available registers in the compiler symbol table.

16. The method of claim 13, wherein executing the compiled representation of source code comprises:
selecting an available register from the allocated set of available registers based a variable calculated during an execution of the compiled representation of source code; and
storing a first value to the selected available register or loading a second value from the selected available register.

17. The method of claim 12, wherein the representation of source code comprises at least one of:
the source code; or
an intermediate representation (IR) of the source code.

18. The method of claim 12, further comprising:
identifying the set of temporary arrays as arrays of the representation of source code having an index whose value is unknown during a compile time of the representation of source code.

19. The method of claim 12, further comprising:
allocating the set of temporary arrays to a set of memory locations in a private memory in response to the first size being greater than or equal to the second size; and
compiling the representation of source code to store the set of temporary arrays to the allocated set of memory locations in the private memory.

20. A computer-readable medium storing computer executable code, the code when executed by a processor, causes the processor to:
obtain a representation of source code comprising a set of temporary arrays;
determine a first size of the set of temporary arrays based on the obtained representation of source code;
determine whether the first size of the set of temporary arrays is less than or equal to a second size of a set of available registers in a compiler symbol table;
allocate the set of temporary arrays to the set of available registers in the compiler symbol table in response to the first size being less than or equal to the second size;
compile the representation of source code to store the set of temporary arrays to the allocated set of available registers; and
output an indication of the compiled representation of source code.
